(19) United States
(12) Patent Application Publication
(10) Pub. No.: US 2012/0186172 A1
(43) Pub. Date: Jul. 26, 2012

(54) CONSTRUCTION SYSTEM FOR BUILDINGS

(76) Inventor: André Bouchard, Alma (CA)

(21) Appl. No.: 13/147,022

(22) PCT Filed: Feb. 8, 2010
(86) PCT No.: PCT/CA2010/000174

§ 371 Date: Oct. 5, 2011

Related U.S. Application Data
(60) Provisional application No. 61/150,371, filed on Feb. 6, 2009.
(60) Provisional application No. 61/286,826, filed on Dec. 16, 2009.

(51) Int. Cl. E04B 2/08; E06B 1/32; E04C 1/00

(52) U.S. Cl. 52/204.1; 52/589.1; 52/590.2; 52/585.1

(57) ABSTRACT

A building block for constructing a wall comprises a main body. The main body has an insulating core with concrete inner and outer shell members. The inner and outer shell members respectively cover inner and outer lateral surfaces of the insulating core. A vertical throughbore in the main body receives a vertical structural member. Top and bottom surfaces of the main body have complementary shapes for mating engagement when blocks are assembled one on top of the other. A female connector at a first end of the main body defines a retaining cavity. A male connector at a second end of the main body has a captive portion of shape complementary to the retaining cavity of the female connector, and blocks engagement in vertical and longitudinal directions when the blocks are assembled end to end. A construction system is also provided.

### CROSS-REFERENCE TO RELATED APPLICATIONS

The present application claims priority on U.S. Provisional Patent Application No. 61/150,371, filed on Feb. 6, 2009, and on U.S. Provisional Patent Application No. 61/286,826, filed on Dec. 16, 2009, both incorporated herein by reference.

### FIELD OF THE APPLICATION

The present application relates to construction systems for erecting dwellings and, more particularly, to such systems involving concrete construction blocks.

### BACKGROUND OF THE ART

Concrete is a commonly used material for erecting buildings. Concrete is structurally strong and is made of relatively inexpensive elements, including aggregate, water and a binder such as cement. However, concrete buildings typically require a non-negligible amount of manpower, equipment and temporary structures, to pour the concrete into forming walls of a dwelling.

Accordingly, various types of construction systems involving prefabricated concrete blocks have been developed in order to reduce the on-site erection of walls, by forming the blocks off site with specialized equipment, and simply assembling the prefabricated blocks on site.

### SUMMARY OF THE APPLICATION

It is therefore an aim of the present application to provide a novel construction system including construction blocks.

Therefore, in accordance with a first embodiment of the present application, there is provided a block used as a building block in constructing a wall, comprising: a main body comprising an insulating core with a concrete inner shell member and a concrete outer shell member respectively covering inner and outer lateral surfaces of the insulating core, and at least one vertical throughbore in the main body for receiving a vertical structural member; a top surface and a bottom surface of the main body having complementary shapes for mating engagement therebetween when said blocks are assembled one on top of the other; a female connector at a first end of the main body, the female connector defining a retaining cavity; and a male connector at a second end of the main body, the male connector having a captive portion of shape complementary to the retaining cavity of the female connector for blocking engagement in at least one of a vertical direction and a longitudinal direction when said blocks are assembled end to end.

Further in accordance with the first embodiment, the retaining cavity and the captive portion have dovetail outlines to concurrently form a dovetail joint when said blocks are assembled end to end.

Still further in accordance with the first embodiment, the top surface of the main body has at least a pair of parallel longitudinal ribs, and the bottom surface has a complementary longitudinal channel for each of the longitudinal rib for the mating engagement when said blocks are assembled one on top of the other.

Still further in accordance with the first embodiment, the longitudinal ribs are defined at least partially by the concrete shell members.

Still further in accordance with the first embodiment, lateral clearances are provided at a first end of the main body, and lateral projections are provided at a second end of the main body, the lateral projections received in the lateral clearances when said blocks are assembled end to end.

Still further in accordance with the first embodiment, the lateral clearances and lateral projections are defined at least partially by the concrete shell members.

Still further in accordance with the first embodiment, the at least one throughbore is in the insulating core.

Still further in accordance with the first embodiment, a plurality of the throughbore are provided, each of the throughbore being equidistantly spaced from one another on along a longitudinal axis of the main body.

Still further in accordance with the first embodiment, open throughbore portions are provided in both the male connector and the female connector, the open throughbore portions concurrently forming one of the throughbores when the blocks are assembled end to end.

Still further in accordance with the first embodiment, the insulating core is made of polyurethane.

Still further in accordance with the first embodiment, the polyurethane of the insulating core has isocyanate and polyol, the isocyanate content greater than the polyol content.

Still further in accordance with the first embodiment, the concrete of the shell members comprises at least silicate sand, dyes, polymers, fiber material, and water when worked.

Still further in accordance with the first embodiment, an adhesive layer is provided between the shell members and the insulating core.

Still further in accordance with the first embodiment, the top surface for the main body has a non-linear outline widthwise in the main body, the non-linear outline being constant lengthwise in the main body, and the bottom surface of the main body has a non-linear outline widthwise in the main body, the non-linear outline being constant lengthwise in the main body, the non-linear outline of the bottom surface being complementary to the non-linear outline for mating engagement therebetween when said blocks are assembled one on top of the other.

Still further in accordance with the first embodiment, the retaining cavity has a tapered shape from top to bottom with respect to the main body, and further wherein the captive portion of the male connector has tapered geometry from top to bottom with respect to the main body for the mating engagement when said blocks are assembled one on top of the other.

In accordance with a second embodiment of the present application, there is provided a construction system for buildings comprising: a plurality of the block described in the first embodiment; and elongated rods dimensioned to be received in a plurality of the vertical throughbores in register in some of the blocks assembled one on top of the other.

Further in accordance with the second embodiment, ends of the elongated rods are threaded, the system further comprising coupling nuts screwable to ends of the elongated rods to connect the elongated rods end to end.

Still further in accordance with the second embodiment, grout is provided in columns of the vertical throughbores that are without the elongated rods.

Still further in accordance with the second embodiment, at least one sill member is provided, the sill member comprising an inverted U-shape, with an undersurface of a central portion of the U-shape having a profile complementary to the top surface of the main body for mating engagement between the central portion of the U-shape and the main body when an opening for window/door is defined in an erected wall, and with lateral portions of the inverted U-shape covering exposed surfaces of the shell members.

Still further in accordance with the second embodiment, C-section jamb members are sized to cover ends of the blocks while covering exposed surfaces of the shell members adjacent to the ends of the blocks.

Still further in accordance with the second embodiment, at least one lintel member is provided, the lintel member having a body with a cross section similar to the main body of the blocks, the lintel member sized to have opposed ends thereof extend beyond ends of the blocks defining an opening for window/door in an erected wall, a top surface of the body of the lintel member shaped for mating engagement with a bottom surface of blocks seated on top thereof.

Still further in accordance with the second embodiment, the lintel member has projections extending beyond the body to cover exposed surfaces of ends of the shell members of adjacent ones of the blocks.

Still further in accordance with the second embodiment, end plates are provided, the end plates having a throughbore for engaging with ends of the elongated rods emerging out of the vertical throughbores and extending beyond the top of walls formed by the blocks.

Still further in accordance with the second embodiment, corner blocks are provided, the corner blocks being similar to the blocks in construction, with the main body being separated in two segments interconnected to one another at an angle.

Still further in accordance with the second embodiment, at least one lintel member is provided, the lintel member having a concrete U-shaped shell with an insulating core, the lintel member having a cross section similar to the main body of the blocks, the lintel member sized to have opposed ends thereof extend beyond ends of the blocks defining an opening for window/door in an erected wall, a top surface of the body of the lintel member shaped for mating engagement with a bottom surface of blocks seated on top thereof.

### BRIEF DESCRIPTION OF DRAWINGS

FIG. 1 is a perspective view of a construction block in accordance with an embodiment of the present disclosure;

FIG. 2 is a side elevation view of a platform for a construction system of the present application;

FIG. 3 is a schematic view illustrating anchoring holes being drilled in the platform through a first row of the construction block of FIG. 1;

FIG. 4 is a sectional view of the one of the construction blocks of FIG. 1 being adjusted in height with regard to the platform, using an adjustment screw;

FIG. 5 is a perspective view of the adjustment screw of FIG. 4;

FIG. 6 is a perspective view of rods being used to structurally relate rows of the construction blocks;

FIG. 7 is a top sectional view of a spacer and temporary end plates used to define a door between rows of the construction block of FIG. 1;

FIG. 8 is a perspective view of the wall of FIG. 6, with grout being poured into throughbores of the construction block;

FIG. 9 is a perspective view of a sill member being installed in the wall of construction blocks;

FIG. 10 is a perspective view of the sill member of FIG. 9;

FIG. 11 is an end elevation view of the sill member of FIG. 9;

FIG. 12 is a schematic view of coupling nuts being installed at the end of the rods to secure the rods to the wall of construction blocks;

FIG. 13 is a perspective view of jamb members being used with the sill member to define a window frame;

FIG. 14 is a front elevation view of a sill member and seals used in combination with jamb members to define a frame of a door of the dwelling;

FIG. 15 is a schematic view illustrating the pouring of grout into the jamb members of the windows and doorframes of the dwelling;

FIG. 16 is a perspective view illustrating an installation of a lintel member for a window of the dwelling;

FIG. 17A is a perspective view of the lintel member in accordance with one embodiment;

FIG. 17B is a side elevation view of the lintel member of FIG. 17A;

FIG. 18A is a perspective view of the lintel member in accordance with another embodiment, with a single-piece reinforced concrete shell;

FIG. 18B is a side elevation view of the lintel member of FIG. 18A;

FIG. 19 is a perspective view of a truss support base being installed in a row of the construction block of the dwelling;

FIG. 20 is a perspective view illustrating the installation of closing plates atop the construction blocks once the wall is completed;

FIG. 21 is a sectional view illustrating the closing plate with regard to the rod and the construction blocks;

FIG. 22 is a perspective view illustrating an installation of trusses in the truss support bases atop the walls of the dwelling;

FIG. 23 is a perspective view of the truss of FIG. 22, in a multi-segment construction;

FIG. 24 is a perspective view showing the installation of bracing members between trusses;

FIG. 25 is a perspective view illustrating the installation of a support plate atop the walls of the dwelling;

FIG. 26 is a perspective view showing a transverse base being positioned on top of a construction block;

FIG. 27A is a sectional view showing a gutter member and truss end with respect to a truss;

FIG. 27B is a sectional view showing another gutter;

FIG. 28A is a perspective view of roof blocks as positioned on trusses and in relation with gutter members;

FIG. 28B is a sectional view of a roof block installed on a gutter member;

FIG. 29 is a perspective view of a roof block, in accordance with another embodiment of the present disclosure;

FIG. 30 is a perspective view of a roof block, in accordance with yet another embodiment of the present disclosure;

FIG. 31 is a perspective view of a roof block, in accordance with yet another embodiment of the present disclosure;

FIG. 32 is a cross-section view of a reinforced concrete beam, in accordance with yet another embodiment of the present disclosure;

FIG. 33 is an elevation view of the reinforce concrete beam of FIG. 32;

FIG. 34 is a perspective view of another example of the construction block of FIG. 1, of shorter dimensions;

FIG. 35 is an enlarged perspective view of a male connector end of the construction block of FIG. 1;

FIG. 36 is an end elevation view of the male connector end of the construction block of FIG. 1; and

FIG. 37 is an enlarged perspective view of a female connector end of the construction block of FIG. 1.

### DESCRIPTION OF PREFERRED EMBODIMENTS

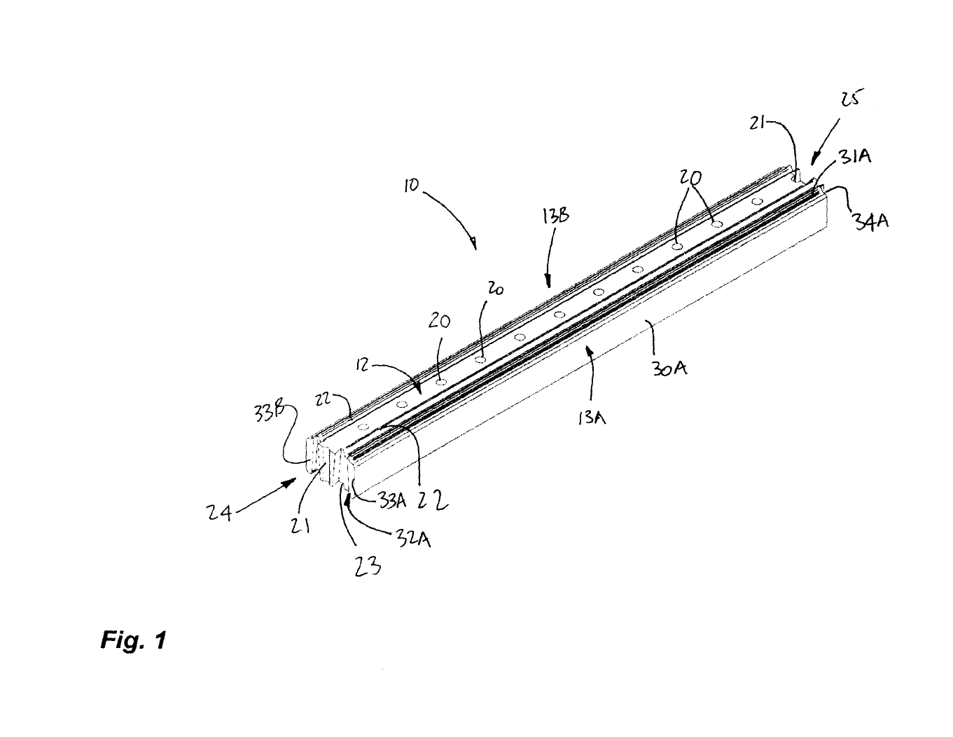

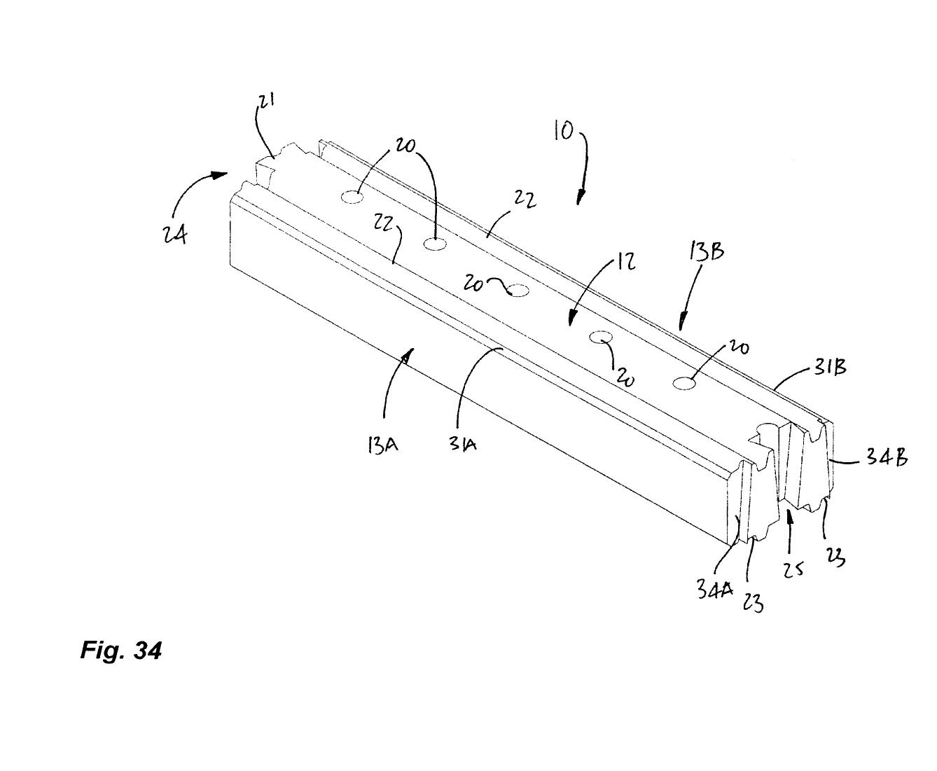

Referring to FIGS. 1 and 34, a construction block of a construction system of the present disclosure is generally shown at 10, with FIGS. 1 and 34 showing different sizes of the block 10. The construction block 10 is installed end to end so as to form rows of a wall. Rows are assembled one on top of the other so as to erect the wall vertically. The construction block 10 has a main body defined at least by an insulating core 12, as well as an outer shell 13A and an inner shell 13B, both made of concrete.

The insulating core 12 is typically made of a polymer such as a foam (e.g., urethane), and will provide the insulating properties to the construction block 10. The outer shell 13A and the inner shell 13B provide the structural properties to the construction block 10. It is pointed out that the insulating core 12 will provide part of the structural properties of the wall erected with the construction blocks 10, notably by the insertion of rods and grout into the insulating core 12, as will be described hereinafter.

Still referring to FIG. 1, the insulating core 12 has throughbores 20 in FIG. 1. Although a plurality of throughbore 20 is illustrated in FIG. 1, it is considered to provide one or more of the throughbores 20 along the construction block 10. Moreover, the insulating core 12 has half-throughbores 21 at opposite ends thereof, such that circular throughbores are formed when construction blocks 10 are installed end to end. The half-throughbores 21 are in the same plane as the throughbores 20, and the longitudinal axes of the throughbores 20 and half-throughbores 21 are parallel to one another. The throughbores 20 are equidistantly spaced along the longitudinal axis of the construction block 10.

An upper surface of the insulating core 12 is provided with ribs 22. The ribs 22 may have a semicircular section, or any other suitable section. On the lower surface of the insulating core 12, channels 23 with a section complementary to that of the ribs 22 are provided in the insulating core 12. Accordingly, when construction blocks 10 are installed one on the other, the ribs 22 of a bottom construction block 10 are mated with the channels 23 of a top construction block 10. By this mating engagement, the insulating cores 12 are aligned one on top of the other, and can move along one another.

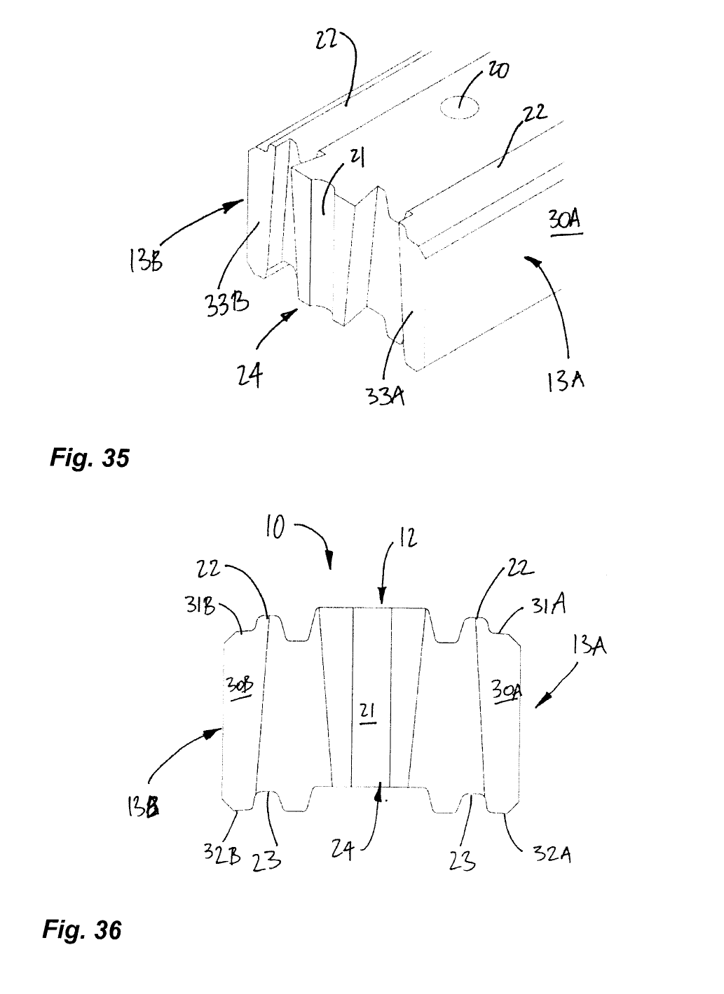

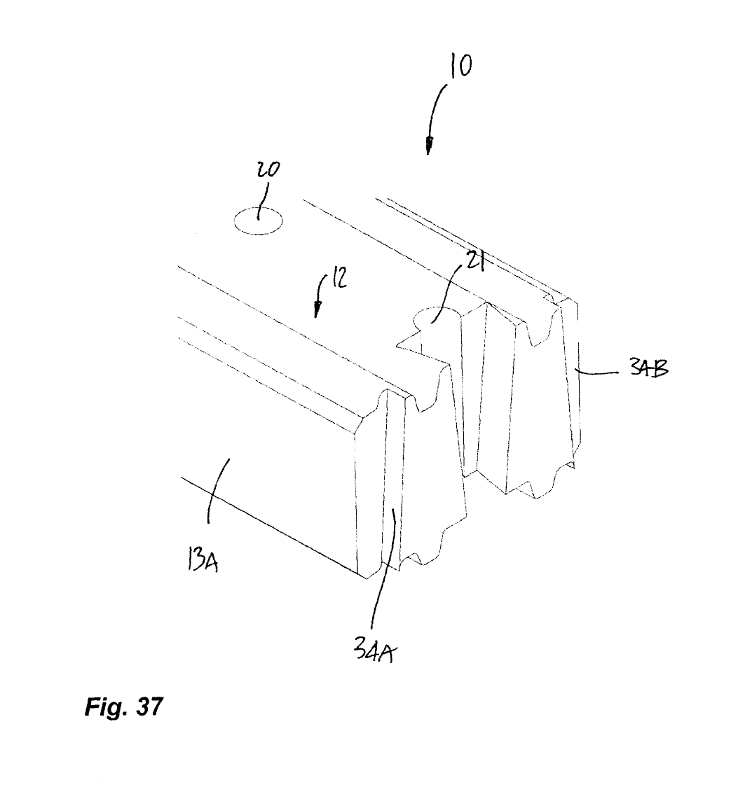

As seen concurrently in FIGS. 1, 35 and 36, a male connector 24 is defined at one end of the insulating core 12, and may feature one of the half-throughbore 21. The male connector 24 has a captive portion defining for instance a flared shape from a top plan standpoint (e.g., dovetail). The captive portion may taper downwardly from an end elevation standpoint.

As seen concurrently in FIGS. 1 and 36, a female connector 25 has a shape complementary to that of the male connector 24 is provided at the other end, and therefore defines a retaining cavity. Accordingly, when construction blocks 10 are assembled end to end, the male connector 24 is mated with the female connector 25. The flaring shape of the male connector 24 and corresponding shape of the female connector 25 ensure that the construction blocks 10 are interlocked longitudinally. Moreover, the tapering shape of the male connector 24 and corresponding shape of the female connector 25 ensure that the construction blocks 10 are limited in moving vertically with respect to one another. Any other suitable shape is considered as well. The shapes of the male connector 24 and of the female connector 25, with or without the geometries described above, cooperate to provide some blocking engagement in at least one of a vertical direction and a longitudinal direction when the blocks 10 are assembled end to end.

The outer shell 13A and the inner shell 13B are similar in construction to one another, whereby their components will be described jointly with reference numerals 30 to 34. However, in FIG. 1, suffixes A and B will be added to illustrate whether the components 30-34 are part of the outer shell 13A or the inner shell 13B, with the A representing the outer shell and B representing components of the inner shell.

The shells 13 each have a core wall 30. The core wall 30 has the same length and height as the inner/outer surfaces of the insulating core 12 (excluding the ribs 22). Therefore, the core walls 30 cover the inner and outer surfaces of the insulating core 12. A longitudinal channel 31 is provided on a top surface the core wall 30. Accordingly, a longitudinal ridge 32 is defined in a bottom surface of the construction block 10. Moreover, the wall 30 is longitudinally offset from the insulating core 12, whereby a lateral projection 33 is formed at an opposite end of the construction block 10. Similarly, a lateral clearance 34 is defined at the opposite end of the construction block 10. Accordingly, when construction blocks 10 are assembled end to end, the lateral projections 33 of a first construction block 10 are received in the lateral clearances 34 of an adjacent second construction block 10. Similarly, when construction blocks 10 are assembled one on top of the other, the longitudinal ridges 31 of a bottom block 10 are fitted into the longitudinal channels 32 of a top construction block 10. Other arrangements are also considered, for instance with bottom ridges and top channels, etc.

As seen from FIG. 36, the top surface of the main body of the block 10 has a non-linear outline widthwise in the main body. The non-linear outline is constant lengthwise in the main body. The bottom surface of the main body of the block 10 has a non-linear outline widthwise in the main body, with the non-linear outline being constant lengthwise in the main body, the non-linear outline of the bottom surface being complementary to the non-linear outline for mating engagement therebetween when the blocks are assembled one on top of the other.

Although FIG. 1 shows an elongated straight construction block 10, the construction system of the present disclosure may also feature angled construction blocks, as will be illustrated in the subsequent figures. The angled construction blocks will be used to define the corners of the dwelling formed therewith. Moreover, the construction blocks 10 may be manufactured in different lengths, or may be cut on site to suitable lengths.

The construction blocks 10 are typically manufactured as an integral piece using bonding techniques by which the insulating core 12 will be molded with the shells 13. According to one embodiment, the insulating core 12 is made of polyurethane, having roughly 54% of isocyanate, for 46% polyol, for example. Other products may be used, or other appropriate proportions of isocyanate/polyol may be used as well. The polyurethane is molded with an injection pressure of about 1500 Psi, to provide a piece having a density of about 2.5 pound/cubic foot.

The shells 13 are made of concrete. One suitable formula of concrete comprises silicate sand, dyes, polymers, fiber material (about 4%), and water. It is considered to position a sheet between the insulating core 12 and shells 13. For instance, a low-density polyethylene sheet may be used, and may be pre-glued with a water-based adhesive. Any other suitable arrangement is considered.

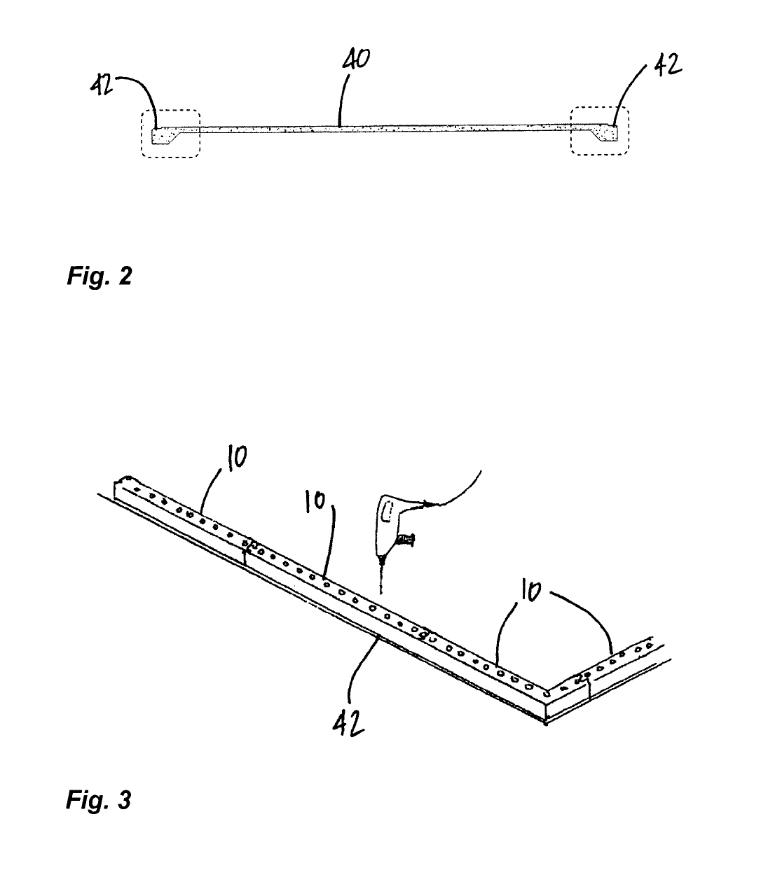

Now that an example of the construction block has been described, a method for assembling a dwelling with the construction block 10 and other components of the construction system will be described, with reference initially to FIG. 2.

Referring to FIG. 2, a platform 40 forming the basis of a dwelling is illustrated. The platform 40 is typically made of concrete or like materials, and features a peripheral ledge 42, that is slightly lower than a remainder of the platform 40. The peripheral ledge 42 will be used to support the walls formed with the construction block 10.

Referring to FIG. 3, once construction blocks 10 and the like have been installed end to end to form a first row, anchoring holes are drilled into the ledge 42 of the platform 40 using a tool such as a drill. With the connector blocks 10 of FIG. 1, the male connector 24 is lowered into the female connector 25 of a construction block 10 already on the ground.

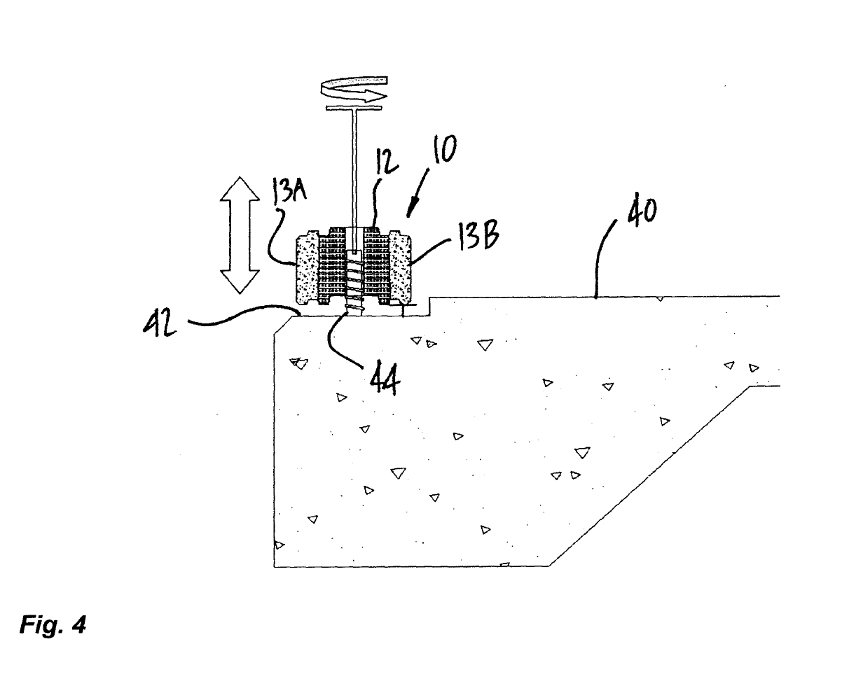

Referring to FIG. 4, an adjustment screw 44 is then used to secure the construction blocks 10 to the platform 40. As illustrated in FIG. 4, it is preferred to provide a gap between the bottom of the construction blocks 10 and the top surface of the ledge 42, which gap will subsequently be filled with cement, concrete, grout or like filler. It is preferred to position the adjustment screws 44 in the throughbores 20 of the construction blocks 10 closest to the ends of the construction blocks 10, in the case of FIG. 3 in which there are a plurality of throughbores 20. It is pointed out that not all throughbores should receive an adjustment screw 44.

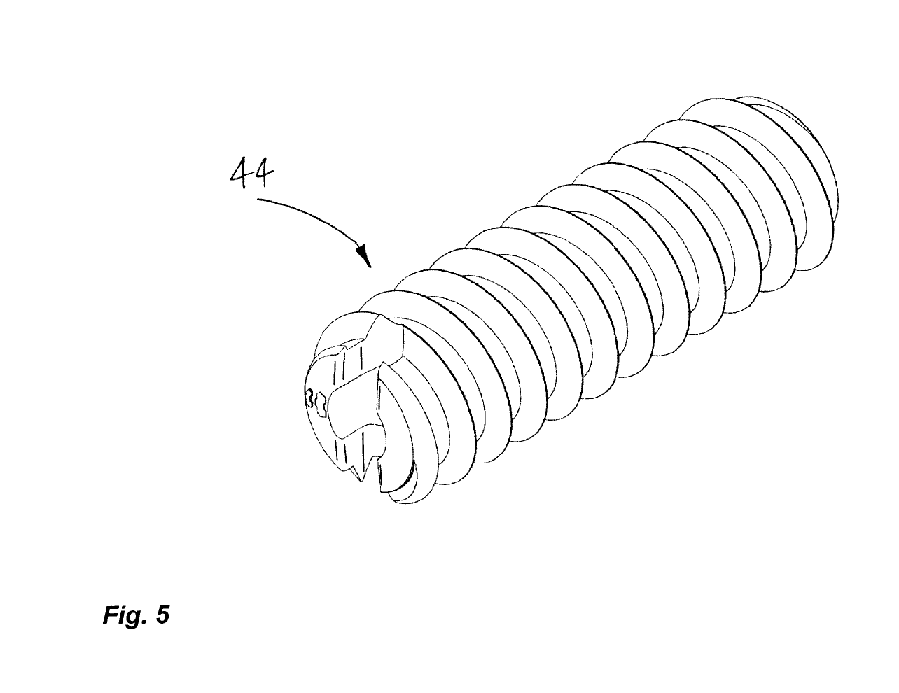

The adjustment screw 44 is shown in greater detail in FIG. 5. The screw 44 may be provided with a slotted end for the use of a flat-head screwdriver. The adjustment screw 44 is preferably self-tapping to cooperate with the material of the construction block 10.

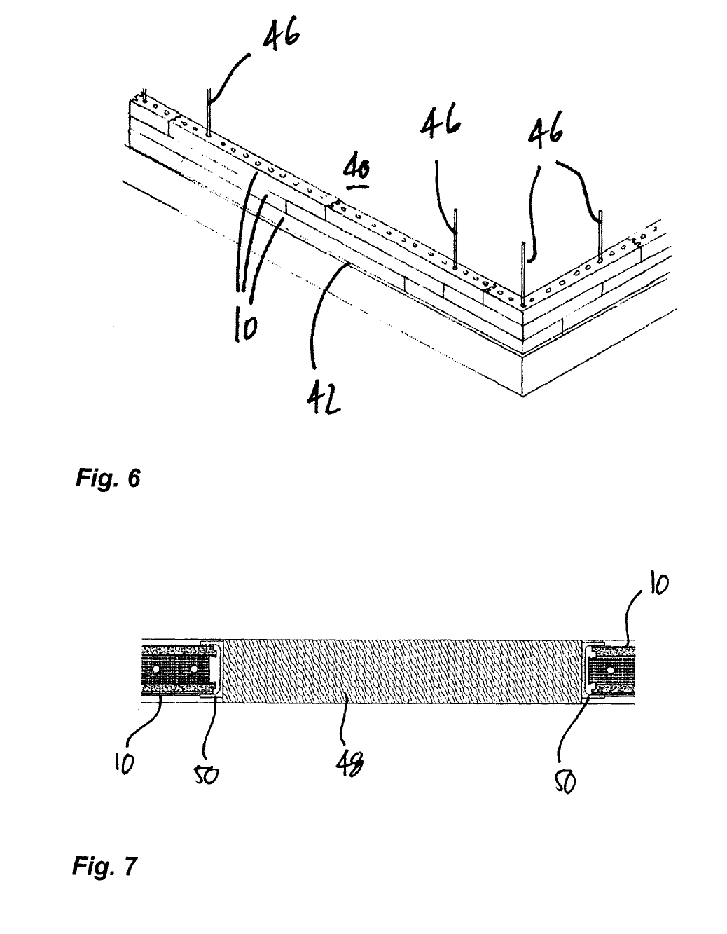

Referring to FIG. 6, a vertical dimension of a wall is defined by assembling different rows of the construction block 10 one on top of the other. The construction blocks 10 are in vertical alignment with one another in such a way that the throughbores 20 of different rows are in vertical register. This allows rods 46 to be inserted into throughbores 20 through the different rows of the construction blocks 10. It is observed from FIG. 6 that the rods 46 are long enough to pass through numerous rows of construction block 10.

Referring to FIG. 7, a spacer 48 is used in combination with temporary end plates 50 to form an opening in the dwelling in which a door will be received. The spacer 48 is typically a horizontal plate that will define the spacing between ends of the wall. The temporary end plates 50 will cooperate to close the gap between the spacer 48 and the ends of the walls of construction block 10. Considering that jamb members will be used subsequently, the temporary end plates 50 typically have a C-section that will be similar in shape and dimensions to that of the jamb members 58. The size of construction blocks 10 used in forming rows is selected as a function of finishing flush at the door openings, and window openings as illustrated hereinafter.

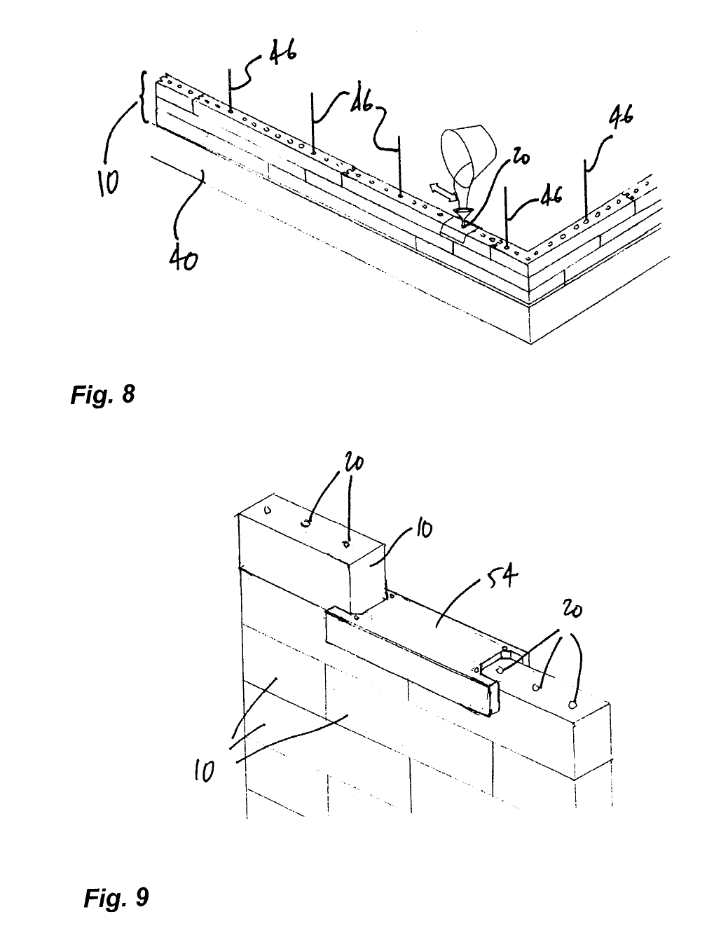

Referring to FIG. 8, grout is inserted into empty columns of throughbores 20. As mentioned previously, the throughbores 20 are in vertical alignment, whereby the grout that is inserted will pour down to lower construction blocks 10. As illustrated in FIG. 8, tools such as a funnel may be used in order to direct the grout in the throughbores 20.

Referring to FIGS. 9-11, sill members 54 are used to define openings in the walls in which windows will be received. The sill members 54 are installed between the construction blocks 10 of a row. As illustrated in FIG. 8, the sill members 54 have end shapes that will overlap lower construction blocks as well as adjacent lateral construction blocks. By way of an example, the sill member 54 is typically made of concrete, although other materials may be used as well. An underside 55 of the sill members 54, as best seen in FIG. 11, is shaped as a function of a geometry of a top surface of the construction block 10.

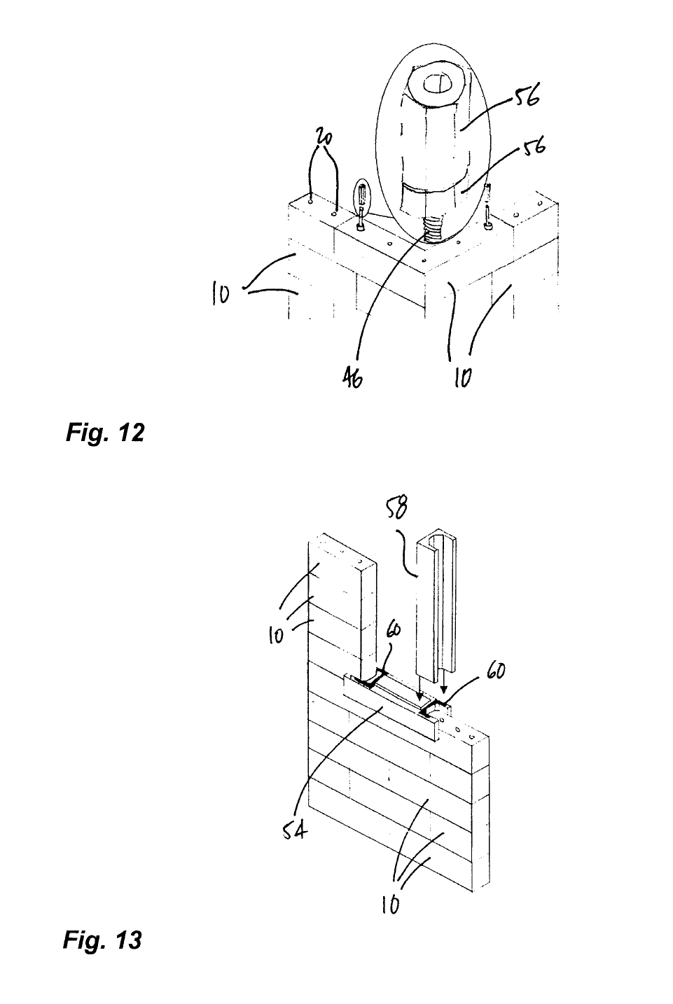

According to FIG. 12, coupling nuts 56 are used at the top of the rods 46. A first coupling nut 56 will abut against an upper surface of the construction blocks 10 to constrain the rod 46, whereas another coupling nut 56 will be used to interconnect an upper rod 46 with a lower rod 46. The nuts 46 are sized so as to be accommodated in the throughbores 20.

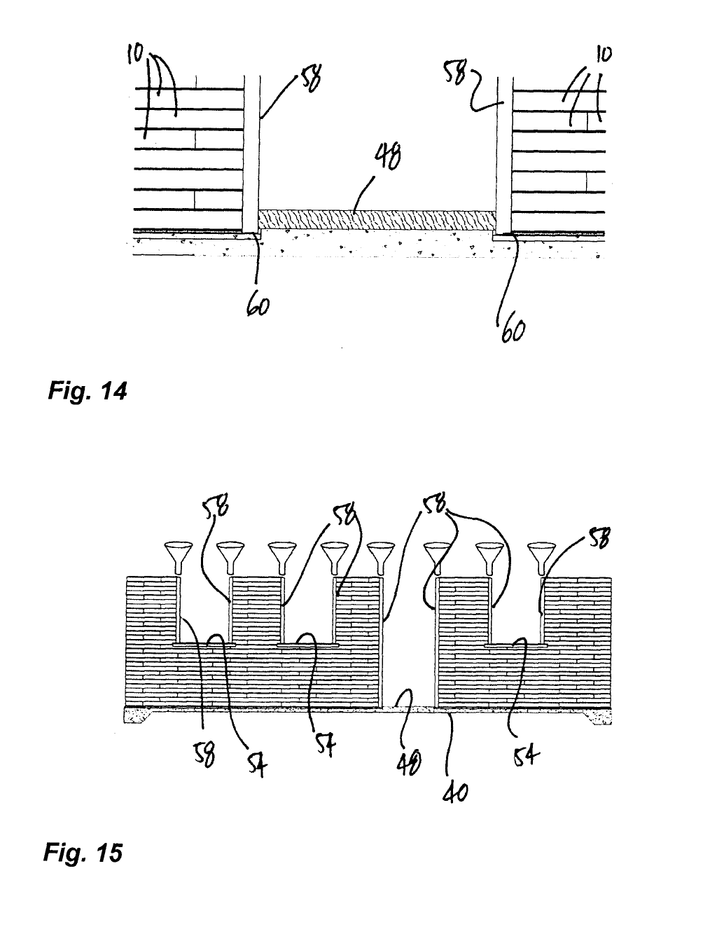

Referring to FIG. 13, jamb members 58, being C-section members, are positioned against the end of the walls and are seated on top of the sill members 54. A seal 60 is typically used at the junction between the sill member 54 and the jamb members 58. The seal 60 provides watertightness and airtightness between the sill member 54 and the jamb members 58. By way of example, the seal 60 is typically made of neoprene or like sealing material. Referring to FIG. 14, the seals 60 may be used with the jamb members 58 of the door frame.

Referring to FIG. 15, grout is poured between the jamb members 58 and the end of the walls of construction blocks 10. Tools such as a funnel may be used to ensure proper infiltration of the grout in the gap within the jamb members 58.

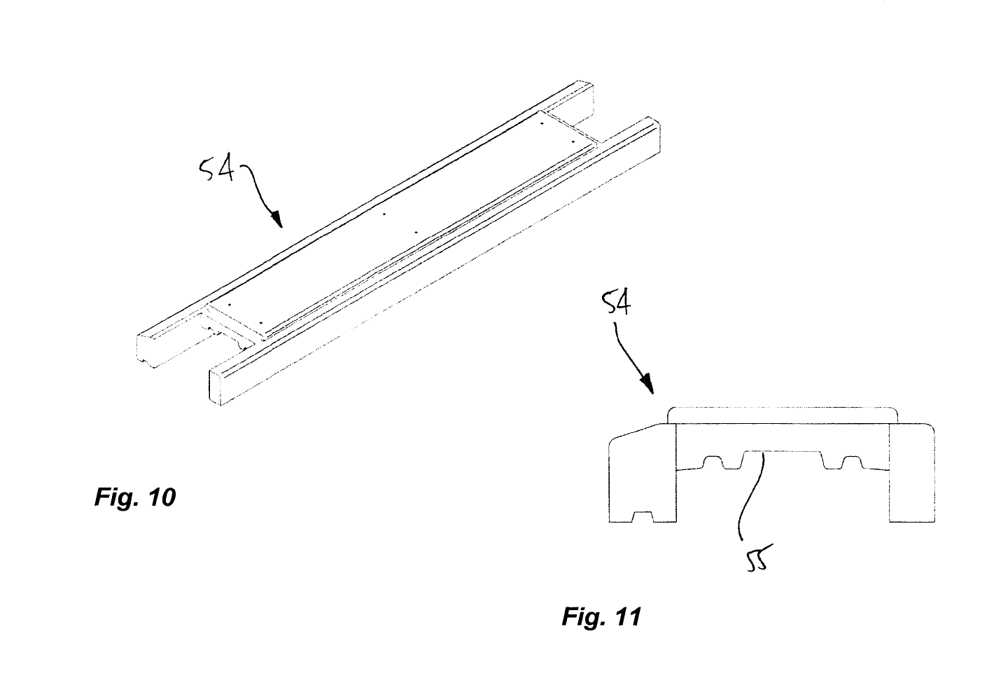

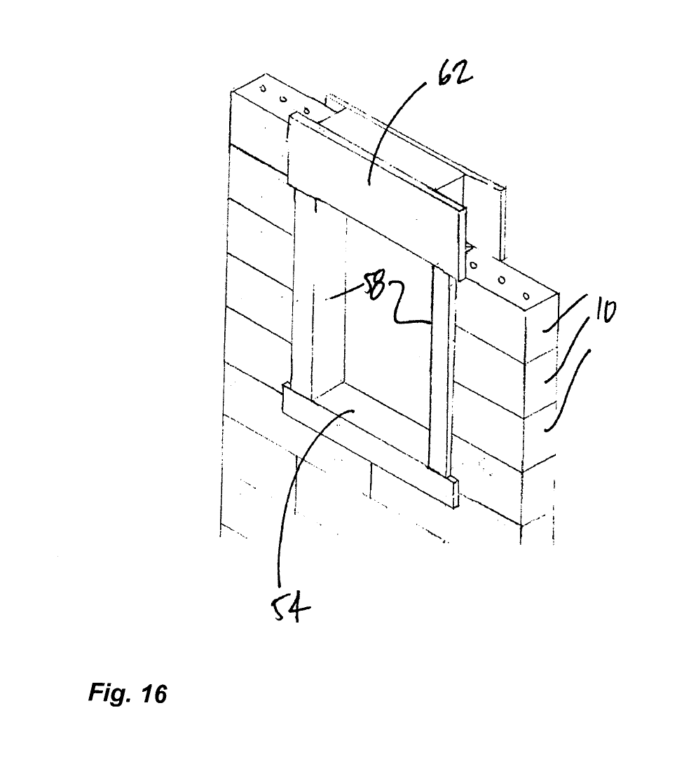

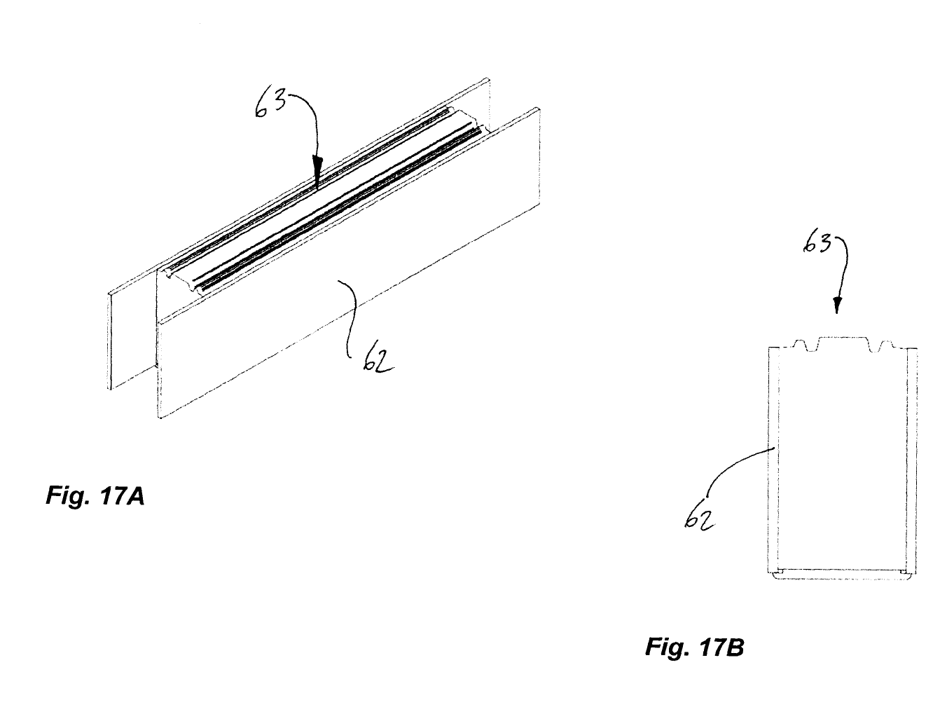

Referring to FIGS. 16-18B, lintel members 62 are then used to form the top end of the frames of the windows and the doors. According to the embodiment shown in FIGS. 17A and 17B, the lintel members 62 have projections that will extend onto the walls. Although not shown, seals 60 (FIG. 10) may be used at the junction between the jamb members 58 and the lintel member 62. The jamb members 58 and the lintel members 62 are typically made of concrete, or any other suitable material. A top surface 63 of the lintel members 62, as best seen in FIGS. 17A and 17B, is shaped as a function of a geometry of an undersurface of the construction block 10.

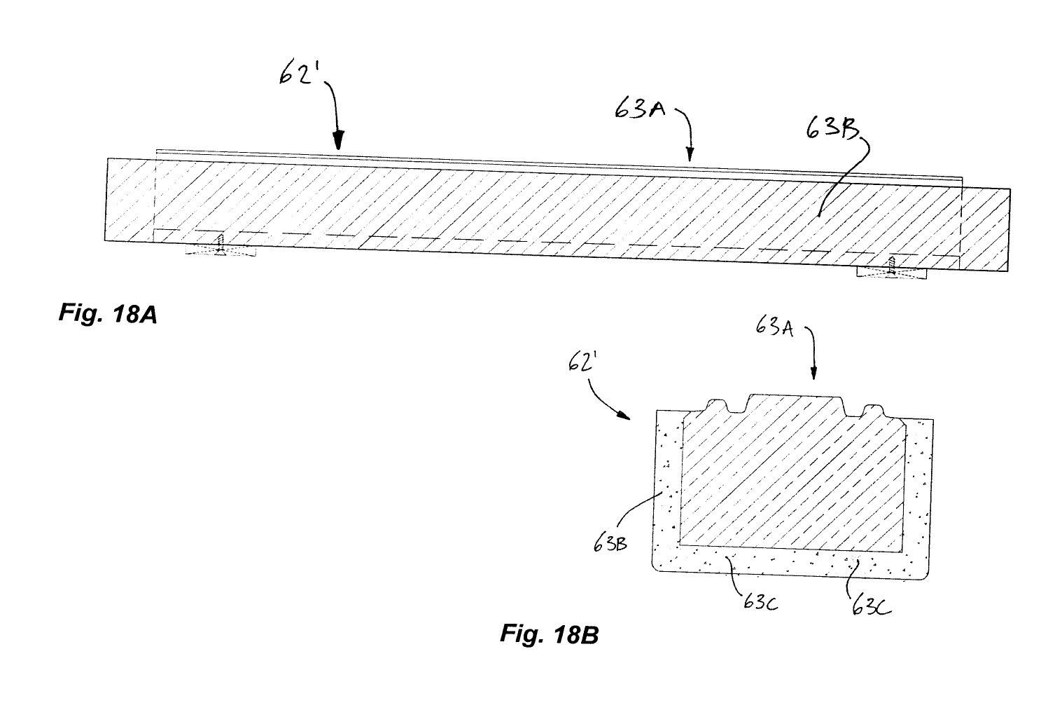

In FIG. 18A and 18B, there is illustrated an alternative embodiment of the lintel member, as illustrated by 62′. The lintel member 62′ also has its top surface 63A shaped as a function of a geometry of an undersurface of the construction block 10, for supporting blocks 10. The lintel member 62′ has a concrete shell 63B having a U-shaped section, to surround a core of insulating material. Reinforcement members 63C may be set into an undersurface of the concrete shell 63B, to reinforce the lintel member 62′. The lateral projections are part of the concrete shell 63B.

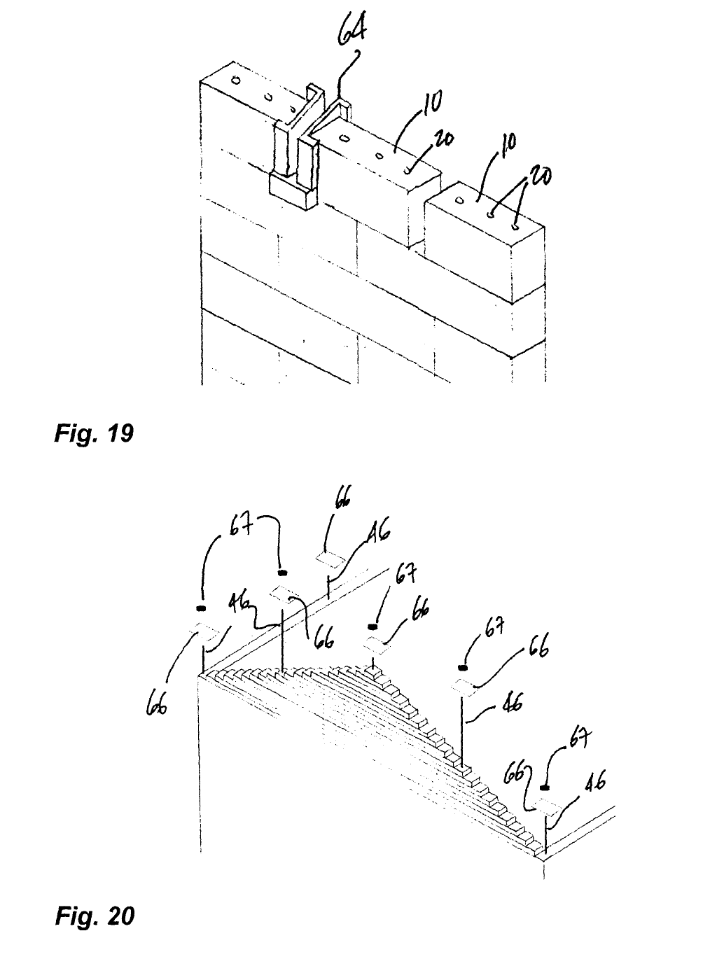

Referring to FIG. 19, truss support bases 64 are inserted between adjacent construction blocks 10 or into spacings cut out in construction blocks 10. The truss support bases 64 will receive ends of trusses, as will be shown in further detail hereinafter.

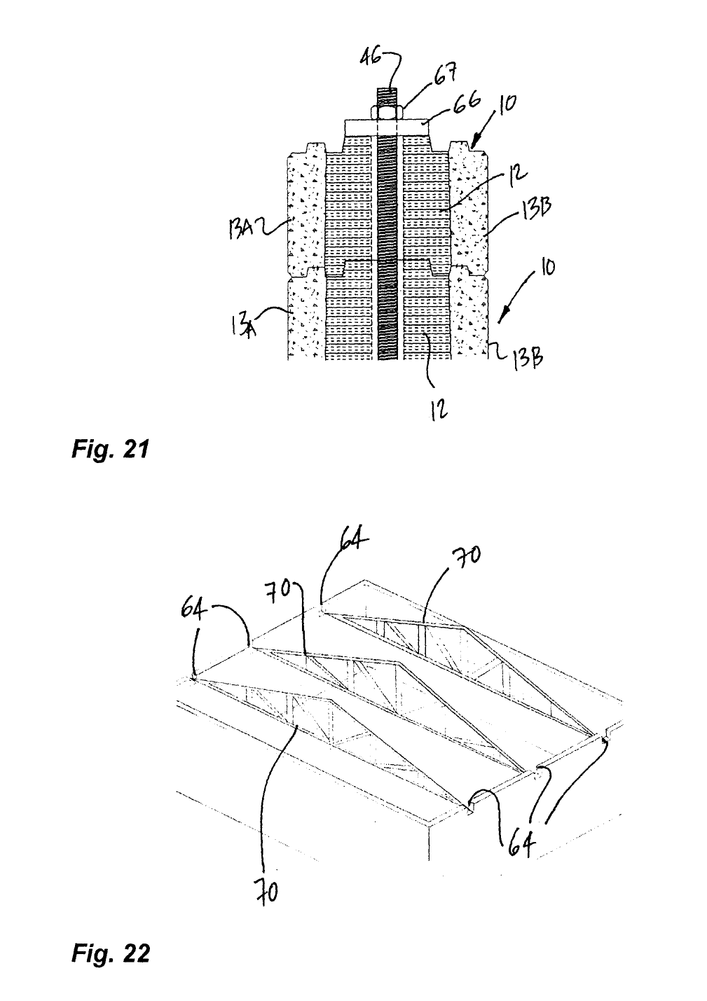

Referring to FIGS. 20 and 21, once the wall has been erected in the manner described previously, closing plates 66 are used so as to close off the throughbores 20 exposed on top of the walls. The closing plates 66 are used in combination with bolts 67 and are positioned at the ends of the rods 46.

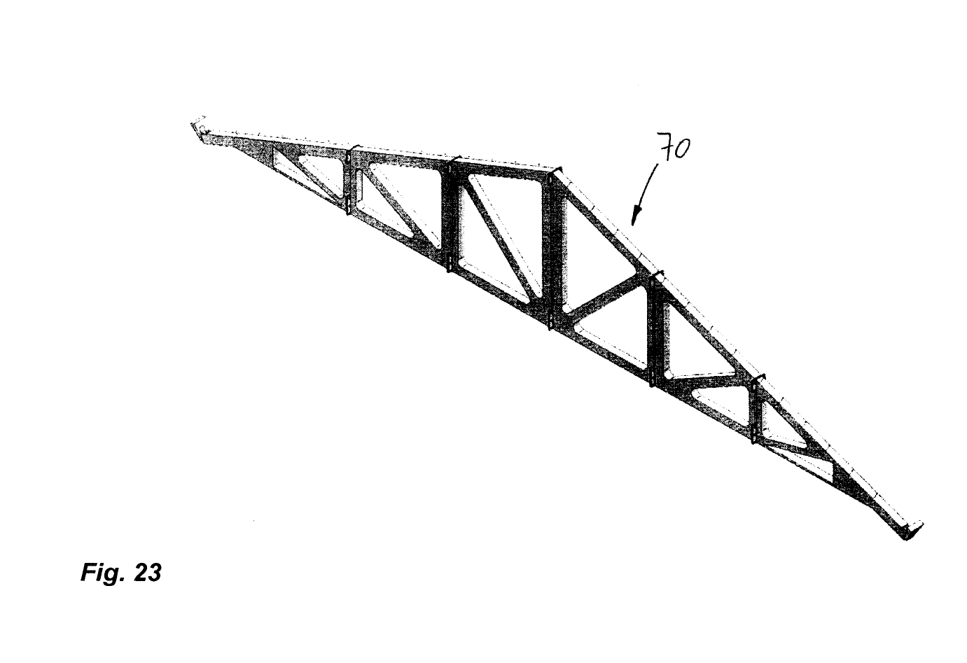

Referring to FIG. 22, the trusses 70 may then be received in the truss support bases 64. The trusses 70 may be made of a metallic material or of concrete. As illustrated in FIG. 23, it is considered to provide the trusses 70 in different segments, using appropriate fasteners such as bolts and nuts so as to interrelate the segments of trusses 70.

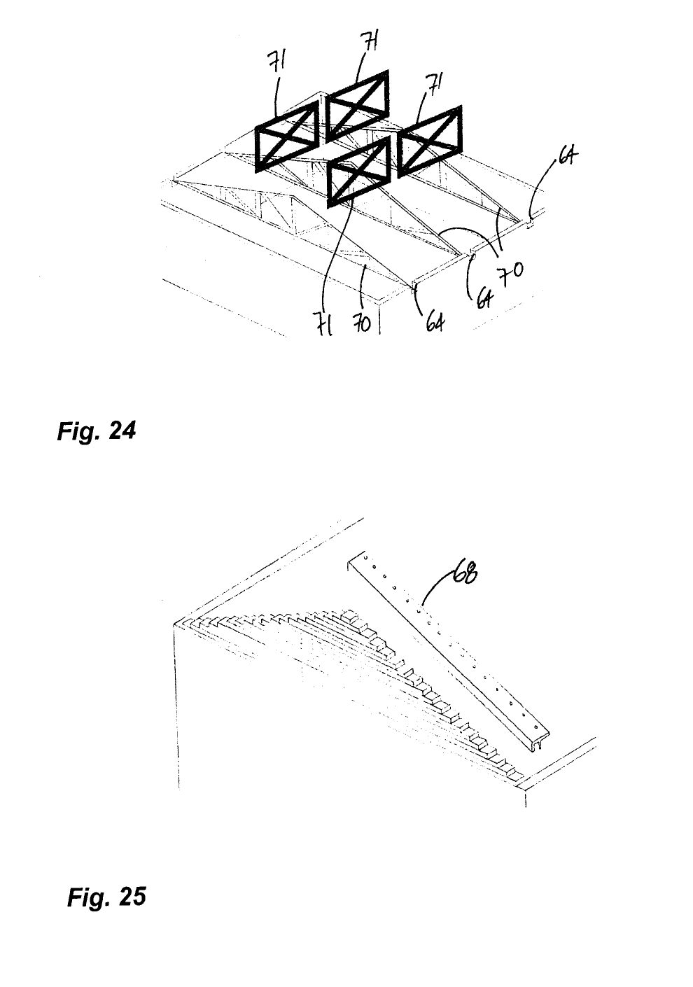

Referring to FIG. 24, bracing members 71 interrelate the trusses 70 with one another. Metallic brackets and the like may be used in order to securely fix the bracing members 71 to the trusses 70 in the manner shown in FIG. 24.

It is preferable to use roof blocks of concrete with the construction system described herein. Accordingly, according to FIG. 25, support plates 68 are installed on top of the walls. The walls of the dwelling are illustrated as having an apex that matches the shape of the trusses 70. The support plates 68 and the top surfaces of the trusses 70 form parallel support surfaces upon which roof blocks will be installed.

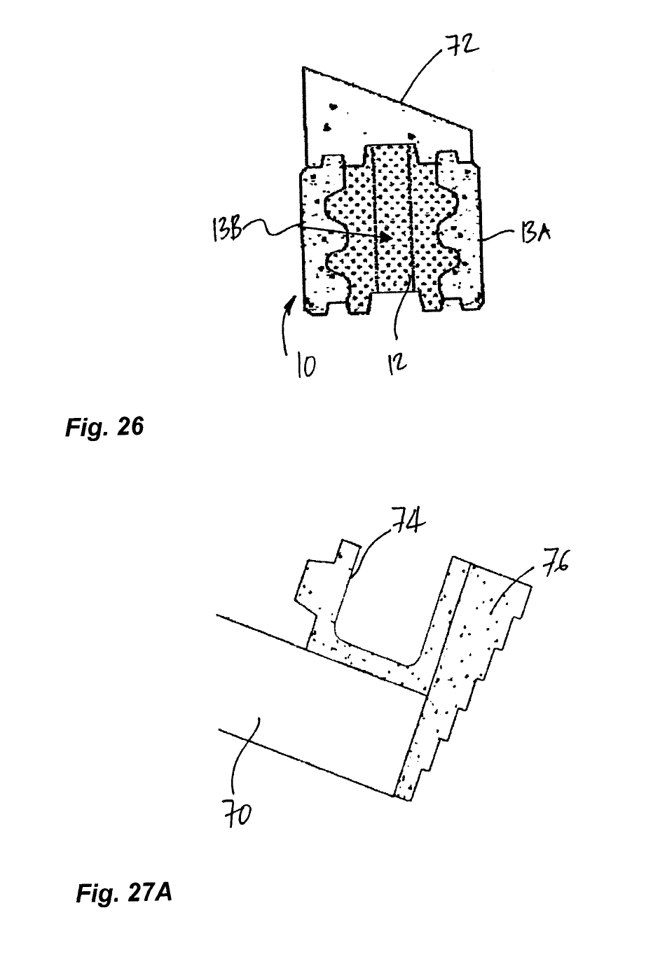

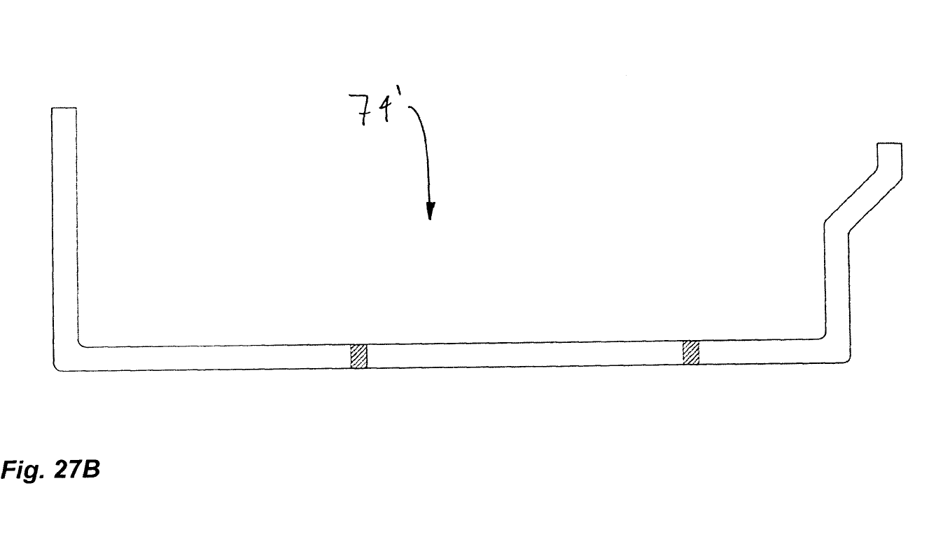

Referring to FIG. 26, a transverse member 72 is positioned on top of the walls between the trusses 70. The top of the transverse member 72 will be flush with that of the trusses 70, whereby the transverse member 72 fills the gap between the top of the walls and the roof blocks. Referring to FIG. 27A, gutter members 74 are positioned at the bottom ends of the trusses 70, with truss ends 76 retaining the gutter members 74 in place.

Referring to FIG. 27B, there is illustrated at 74′ another embodiment of a gutter member. The gutter member 74′ has a first end shaped to mate with roof blocks. The gutter member 74′ may be formed as a unitary piece, for instance in concrete or in metal. Throughbores may be provided in the gutter member 74′, for connection thereof to one of the trusses, or to the structural member supporting the gutter member 74′.

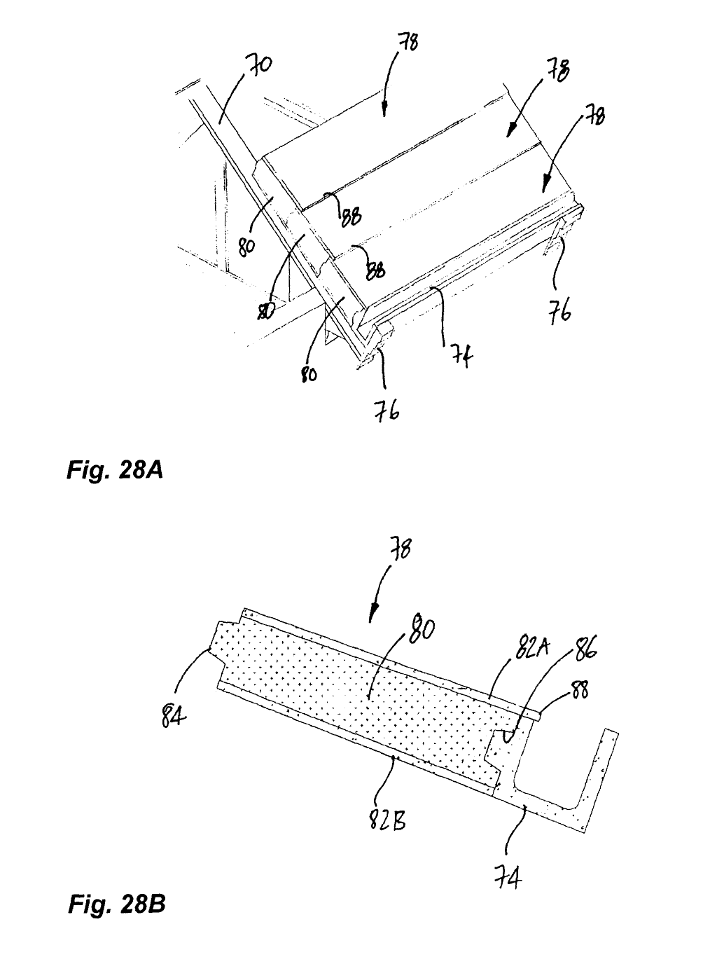

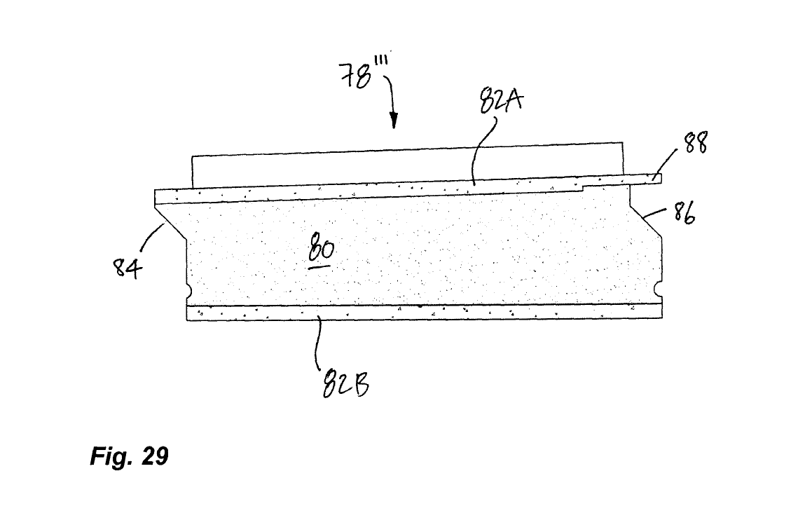

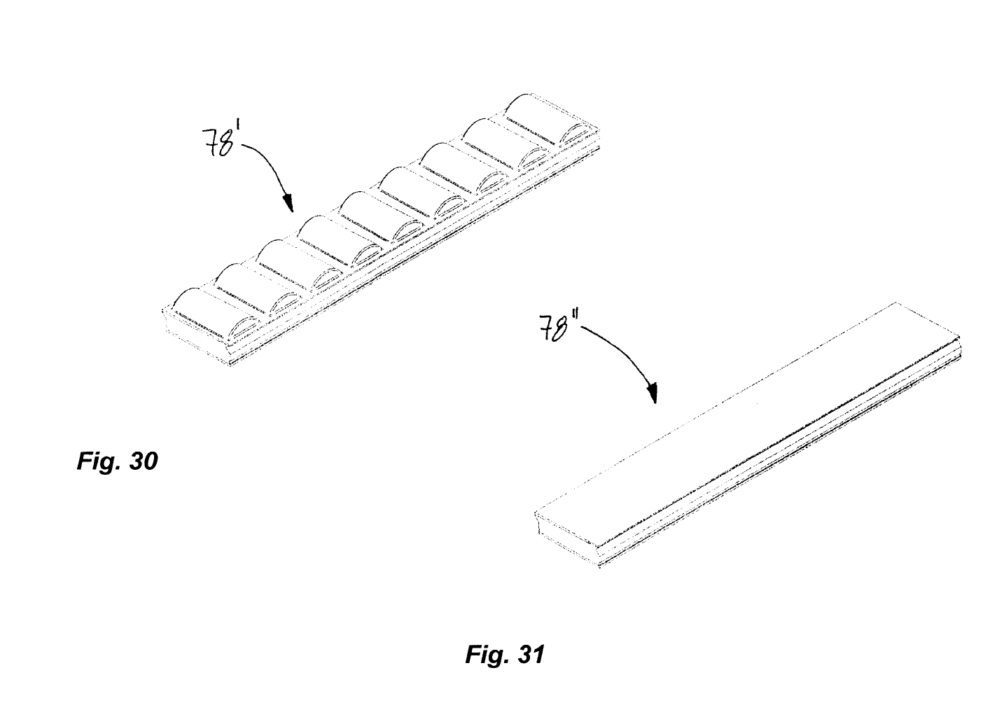

Thereafter, as is illustrated in FIGS. 28A and 28B, the roof blocks 78 are installed on the trusses 70 and on the support plates 68 at the upper ends of the walls. The roof blocks 78 also have an insulating core 80, with an outer shell 82A and an inner shell 82B. The shells 82 are typically made of concrete, and are molded integrally with the insulating core 80. The outer shell 82A may have a waterproof coating or layer The insulating core 80 features a rib 84 on a top end, and a complementarily shaped channel 86 on a bottom end. Therefore, the insulating cores 80 may be mated with one another in the matter shown in FIG. 28A. The insulating cores 80 may be mated with the gutter members 74, as is shown in FIG. 28B. It is pointed out that the roof blocks 78 preferably have a flared bottom end. Accordingly, with the outer shell 82A having a nose 88, the outer shells 82A overlap one another in the manner shown in FIG. 28A and FIG. 28B, to prevent infiltration of liquids between roof blocks 78. FIGS. 29, 30 and 31 illustrate other contemplated shapes of roof blocks, respectively 78′″, 78′ and 78″. The roof blocks 78′″, 78′ and 78″ have a similar construction as the roof block 78, but with different connector geometries and/or different outer shell geometries (e.g., with a Brazilian tile pattern). The roof block 78′″ of FIG. 29 is shaped to be used with the gutter member 74′ of FIG. 27B.

The support plates 68 and trusses 70 may be provided with fasteners projecting upwardly so as to secure the roof blocks 78 thereto.

Following the steps set forth above for FIGS. 2 to 31, a dwelling is erected using the construction system of the present application. Other steps are subsequently performed to finish the dwelling, such as the application of finishing cements on the walls, the installation of windows and doors, and of elastomeric membranes on the roof if necessary.

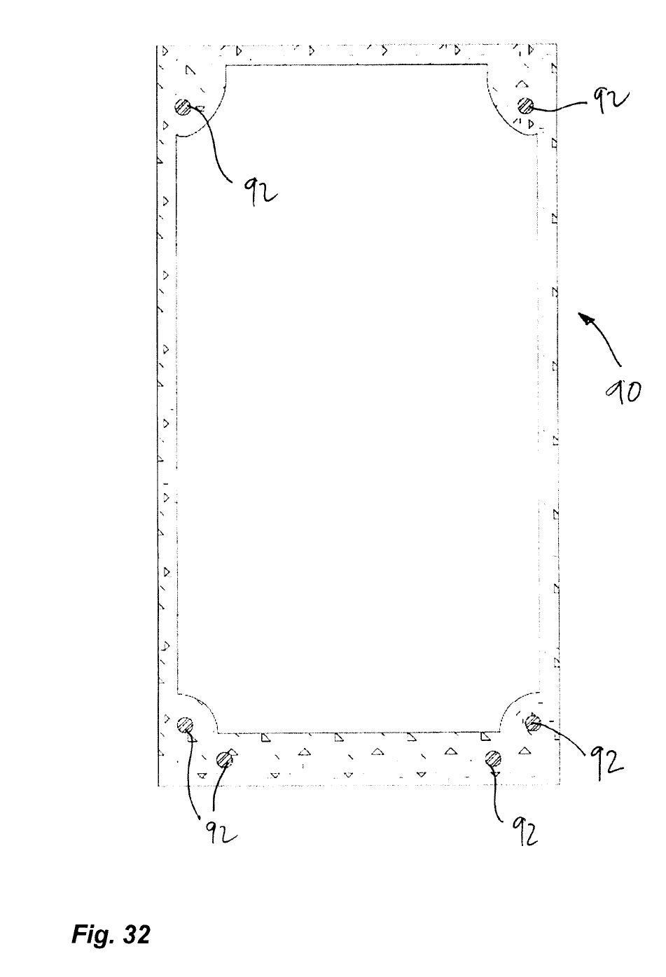

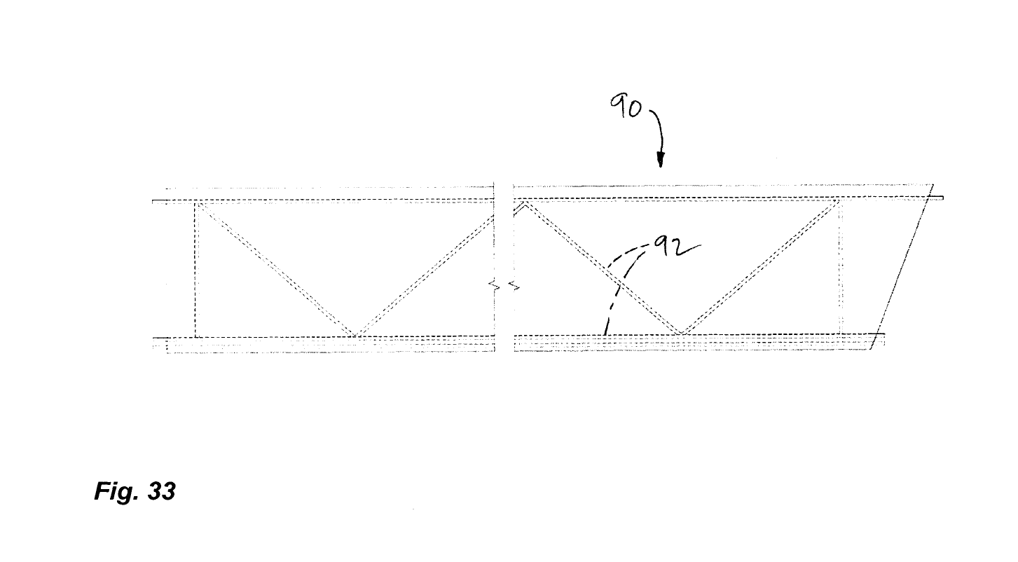

Referring concurrently to FIGS. 32 and 33, a reinforced concrete beam in accordance with another embodiment is generally shown at 90. The beam 90 may be used in any required position in a dwelling constructed with the components of the construction system described above. Reinforcement metallic rods 92 are set in the concrete material of the beams 90. The metallic rods 92 aligned with the edges of the beam 90, or in a cross pattern.

1. A block used as a building block in constructing a wall, comprising:
a main body comprising an insulating core with a concrete inner shell member and a concrete outer shell member respectively covering inner and outer lateral surfaces of the insulating core, and at least one vertical throughbore in the main body for receiving a vertical structural member;
a top surface and a bottom surface of the main body having complementary shapes for mating engagement therebetween when said blocks are assembled one on top of the other;
a female connector at a first end of the main body, the female connector defining a retaining cavity; and
a male connector at a second end of the main body, the male connector having a captive portion of shape complementary to the retaining cavity of the female connector for blocking engagement in at least one of a vertical direction and a longitudinal direction when said blocks are assembled end to end.

2. The block according to claim 1, wherein the retaining cavity and the captive portion have dovetail outlines to concurrently form a dovetail joint when said blocks are assembled end to end.

3. The block according to claim 1, wherein the top surface of the main body has at least a pair of parallel longitudinal ribs, and the bottom surface has a complementary longitudinal channel for each of the longitudinal rib for the mating engagement when said blocks are assembled one on top of the other.

4. The block according to claim 3, wherein the longitudinal ribs are defined at least partially by the concrete shell members.

5. The block according to claim 1, further comprising lateral clearances at a first end of the main body, and lateral projections at a second end of the main body, the lateral projections received in the lateral clearances when said blocks are assembled end to end.

6. The block according to claim 5, wherein the lateral clearances and lateral projections are defined at least partially by the concrete shell members.

7. The block according to claim 1, wherein the at least one throughbore is in the insulating core.

8. The block according to claim 7, further comprising a plurality of the throughbore, each of the throughbore being equidistantly spaced from one another on along a longitudinal axis of the main body.

9. The block according to claim 8, further comprising open throughbore portions in both the male connector and the female connector, the open throughbore portions concurrently forming one of the throughbores when the blocks are assembled end to end.

10.-12. (canceled)

13. The block according to claim 1, comprising an adhesive layer between the shell members and the insulating core.

14. The block according to claim 1, wherein the top surface for the main body has a non-linear outline widthwise in the main body, the non-linear outline being constant lengthwise in the main body, and further wherein the bottom surface of the main body has a non-linear outline widthwise in the main body, the non-linear outline being constant lengthwise in the main body, the non-linear outline of the bottom surface being complementary to the non-linear outline for mating engagement therebetween when said blocks are assembled one on top of the ;other.

15. The block according to claim 1, wherein the retaining cavity has a tapered shape from top to bottom with respect to the main body, and further wherein the captive portion of the male connector has tapered geometry from top to bottom with respect to the main body for the mating engagement when said blocks are assembled one on top of the other.

16. A construction system for buildings comprising:
a plurality of the block as claimed in claim 1; and
elongated rods dimensioned to be received in a plurality of the vertical throughbores in register in some of the blocks assembled one on top of the other.

17. The construction system according to claim 16, wherein ends of the elongated rods are threaded, the system further comprising coupling nuts screwable to ends of the elongated rods to connect the elongated rods end to end.

18. (canceled)

19. The construction system according to claim 16, further comprising at least one sill member, the sill member comprising an inverted U-shape, with an undersurface of a central portion of the U-shape having a profile complementary to the top surface of the main body for mating engagement between the central portion of the U-shape and the main body when an opening for window/door is defined in an erected wall, and with lateral portions of the inverted U-shape covering exposed surfaces of the shell members.

20. The construction system according to claim 19, further comprising C-section jamb members, sized to cover ends of the blocks while covering exposed surfaces of the shell members adjacent to the ends of the blocks.

21. The construction system according to claim 16, further comprising at least one lintel member, the lintel member having a body with a cross section similar to the main body of the blocks, the lintel member sized to have opposed ends thereof extend beyond ends of the blocks defining an opening for window/door in an erected wall, a top surface of the body of the lintel member shaped for mating engagement with a bottom surface of blocks seated on top thereof.

22. The construction system according to claim 21, wherein the lintel member has projections extending beyond the body to cover exposed surfaces of ends of the shell members of adjacent ones of the blocks.

23. The construction system according to claim 16, further comprising end plates having a throughbore for engaging with ends of the elongated rods emerging out of the vertical throughbores and extending beyond the top of walls formed by the blocks.

24. The construction system according to claim 16, further comprising corner blocks, the corner blocks being similar to the blocks in construction, with the main body being separated in two segments interconnected to one another at an angle.

25. The construction system according to claim 16, further comprising at least one lintel member, the lintel member having a concrete U-shaped shell with an insulating core, the lintel member having a cross section similar to the main body of the blocks, the lintel member sized to have opposed ends thereof extend beyond ends of the blocks defining an opening for window/door in an erected wall, a top surface of the body of the lintel member shaped for mating engagement with a bottom surface of blocks seated on top thereof.
